(19) United States
(12) Patent Application Publication
(10) Pub. No.: US 2008/0301971 A1
(43) Pub. Date: Dec. 11, 2008

(54) Device for Drying Capillary Porous Materials by Acoustic Thermal Method

(76) Inventor: Sergei Leonidovich Koretsky, Moscow (RU)

Correspondence Address: DAFFER MCDANIEL LLP, P.O. BOX 684908, AUSTIN, TX, 78768, US

(21) Appl. No.: 12/163,231

(22) Filed: Jun. 27, 2008

Related U.S. Application Data
(63) Continuation of application No. PCT/RU2005/000678, filed on Dec. 29, 2005.

(51) Int. Cl. F26B 3/02; F26B 25/06

(52) U.S. Cl. 34/218; 34/202

(57) ABSTRACT

The invention is related to means of drying various, mainly, capillary porous materials and can be used in agriculture to dry grain and other agricultural products, or in mill industry to dry timber and sawdust, or in food industry to dry food products, and also for similar purposes in other industries. A device for drying capillary porous materials comprises a drying chamber supplied with sound-proof partitions that divide its inner volume into isolated sections, each section being supplied with a separate source of sound, and a source of heated air, executed in such a way that heated air is supplied from said source to each section of the drying chamber. The invention solves the problem of making a drying device suitable for drying capillary porous materials by means of the acoustic thermal method, the device being at the same time simple in design and cost-effective.

### CONTINUING DATA

The present application is a continuation of pending International Application No. PCT/RU2005/000678 filed Dec. 29, 2005 which designates the United States.

### BACKGROUND OF THE INVENTION

1. Field of the Invention

The invention is related to means of drying various, mainly, capillary porous materials and can be used in agriculture to dry grain and other agricultural products, or in mill industry to dry timber and sawdust, or in food industry to dry food products, and also for similar purposes in other industries.

2. Description of the Related Art

Many devices intended for drying materials using different methods are known. In thermal drying dry heated air is widely used as a drying agent and is fed through the drying chamber containing materials to be dried. For example, a timber drier with a drying chamber with two cavities at the bottom is known. Hot combustion products from the burning of wood waste are fed to one cavity from the furnace flue, and the other accumulates a drying agent, hot air heated in the pipes accommodated in the furnace flue [Patent of the Russian Federation No 2153640]. To prepare the drying agent, electric heaters, for example tubular electric heaters, and other known means can be used as sources of heat.

To conduct acoustic drying the drying chamber is supplied with a source of sound that transmits acoustic waves with fixed parameters that interact with the material to be dried and dehumidify it. For example, a device for drying grain by acoustic method is well known which includes a bunker equipped with feeder for supply of bulk solids to the contact heat and mass exchanger, intermediate cooling column connected to the heat and mass exchanger is installed throughout its height in the perforated concentrators sound transmitters with air stream reflectors [Inventor's Certificate of the USSR No 675266, 1979]. The disadvantages of this device are low productivity and high power consumption caused by simultaneous use of several sound transmitters, and also unsuitability to carry out a more perspective method of drying, i.e. acoustic thermal drying.

The acoustic thermal method of drying includes both thermal and acoustic influence on the material to be dried. It uses cyclic influence by an acoustic field on the material to be dried, and in each cycle the material should be preliminarily heated [Patent of the Russian Federation No 2215953, 2003]. The effect from such influence on the material increases, if an interval is provided between cycles. This is sufficient enough for moisture from the internal layers of the material to reach its external layers along capillaries. This method of drying is characterized by lower power consumption in relation to each of the mentioned acoustic and thermal methods of drying.

A device for only acoustic drying is known which contains a drying chamber and a sound transmitter, and the drying chamber is executed in the form of a channel, acoustic duct, along which containers having mesh walls and loading and unloading shutters for materials to be dried [Patent of the Russian Federation No 2095707, 1997] are vertically located. The main disadvantage of this device is its unfitness for carrying out the above mentioned less power consuming acoustic thermal method of drying. This device is taken as the prior art of the invention due to having the greatest quantity of attributes similar to the proposed device.

### BRIEF SUMMARY OF THE INVENTION

The invention solves the problem of making a drying device suitable for drying capillary porous materials by means of the acoustic thermal method, the device being at the same time simple in design and cost-effective.

In accordance with the invention, this object is achieved by a device for drying capillary porous materials, comprising: a drying chamber supplied with a source of sound, and is distinguished by the installation of soundproof partitions in the drying chamber that divide its inner volume into isolated sections, each section being supplied with a separate source of sound; and a source of heated air, executed in such a way that heated air is supplied from said source to each section of the drying chamber.

### BRIEF DESCRIPTION OF THE DRAWINGS

The invention is described below by way of examples, without any limitation of the general inventive concept, on embodiments and with reference to the drawings:

FIG. 1 illustrates a drying chamber diagram of the device.

### DESCRIPTION OF PREFERRED EMBODIMENTS

The assigned task is solved by suggesting a device to dry capillary porous materials that includes a drying chamber, where soundproof partitions dividing its internal space into isolated sections are installed, each section being supplied with a separate sound source, as well as a hot air source is installed so that to supply each section with heated air.

Depending on the kind of materials to be dried the drying chamber can have different configurations.

Thus, to dry timber (logs and boards) it is expedient to make the drying chamber casing in the form of a parallelepiped with lateral vertical walls parallel to each other, horizontal bottom and top walls parallel to each other, soundproof partitions installed horizontally, or, in combined form, horizontally and vertically in the longitudinal direction (along the side of the chamber having a greater length), and also with loading/unloading means executed in the form of opening front or back chamber wall. In this case the sections are located horizontally and have the length equal to the length of the drying chamber. Sources of sound are located in each section on the back or front wall of the chamber. Heated air is supplied separately to each section.

The partitions between sections are made soundproof, for example, they can be executed with two metal layers with soundproof material between them: mineral wool, foam-rubber, foam plastic, etc. The walls of the drying chamber can be executed in the same way.

For bulk materials the drying chamber can be executed in various ways (its cavity can be in the form of a cylinder or parallelepiped), but in order to simplify loading it is expedient to install the sections and, accordingly, soundproof partitions vertically, and install a means for unloading the material at the bottom of each section.

The same design, as described above for timber, can be also used for bulk materials, but in this case materials should be placed in mesh containers with the grid cell size less than the size of fraction of bulk material which are installed in the drying chamber section.

To provide uniformity in acoustic processing of the material to be dried it is necessary to supply the drying chamber with sound absorber located on the side opposite to the wall on which the source of sound is installed. The sound absorber can be executed in the form of a plate made of sound-absorbing material for example, mineral wool, or in the form of special wedges made from sound-absorbing material.

The source of heated air can be executed in the form of a means of air heating (for example, tubular heat exchanger, tubular electric heater, etc) and means of forced feeding of heated air to the drying chamber, for example, a fan.

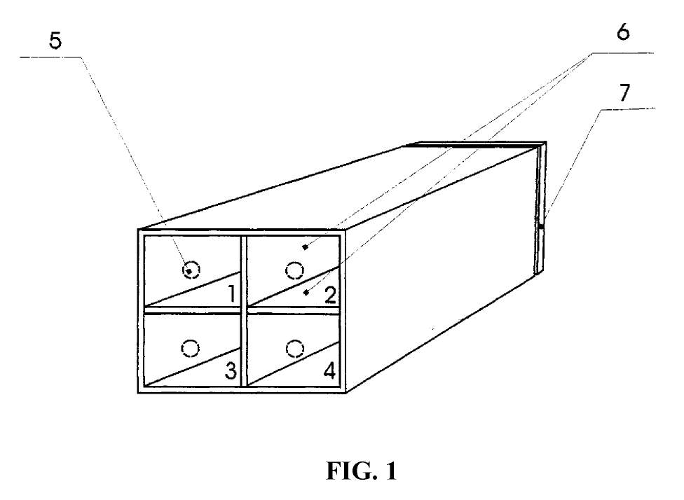

The drying chamber diagram of the device to dry timber with four sections is shown in FIG. 1, where 1, 2, 3, 4 are drying chamber sections, 5 is a sound transmitter, 6 is a soundproofing partition, and 7 is a sound absorber.

The device works as follows (example—timber drying).

The drying chamber, as noted above, is divided by the sound-proof partitions 6 into four sections having a consecutive numeration: 1, 2, 3, 4. It is supposed, that the optimum warming time of the material to be dried by heated air is 4 hours, and optimum time of acoustic irradiation at a cycle is 1 hour.

Air heated to the required degree is supplied to section 1. In 1 hour after the beginning of its supply to section 1 it starts to be supplied to section 2 as well. After 2 hours the heated air is supplied to section 1, 2 and also starts to be supplied to section 3. In 3 hours the heated air is supplied to section 1, 2, 3, and starts to be supplied to section 4. Supply of heated air to all sections simultaneously continues for 1 hour. As a result, during 4 hours of device functioning heated air is supplied to section 1 during 4 hours, to section 2 during 3 hours, to section 3 during 2 hours, to section 4 during 1 hour. After that supply of heated air to section 1 is ended and the sound source is switched on for the next 1 hour, and heated air continues to be supplied during the next hour to the other sections. After that supply of heated air to section 2 is ended and the sound source of this section is switched on for 1 hour. In the next 1 hour supply of heated air to section 3 is stopped and the sound source of this section is also switched on for 1 hour. In the next 1 hour supply of heated air to section 4 is stopped and the sound source of this section is switched on for the next 1 hour. The process repeats further. As a result, in each section the material is processed by heated air during 4 hours, and by sound during 1 hour. The described sequence of operations is repeated several times more until the required final humidity value of the material to be dried is achieved.

In order to provide an identical drying speed of the material over the volume of the drying chamber, it is necessary to maintain an identical sound intensity in its longitudinal and cross sections. In the longitudinal section this problem is solved by the sound absorber installed on the border of the drying chamber, providing environment for a traveling wave in the named section. To maintain an identical sound intensity in the cross-section of the drying chamber it is necessary and sufficient that the sound wave be flat. This requirement imposes a restriction on the choice of transmitted sound frequency (wavelength) at a specified cross-section size of the drying chamber. It is known, that the wave in the acoustic duct will be flat if the following condition is observed [S. N. Rzhevkin, Lectures on the theory of sound, Moscow State University Publishing House, Moscow 1960 (C. H. P [symbol] << [symbol] ypc [symbol] [symbol] [symbol] [symbol] >>—M: [symbol] -Bo [symbol] 1960 [symbol] )]:

Δ<λ/2=c/2f (1)

Here λ is the length of the transmitted sound wave, f is its frequency, c is the speed of sound in the medium where it expands (in the given case the medium is air, therefore c=340 m/s). At the given characteristics of the transmitter, the intensity of the sound J transmitted by it is connected with its characteristic linear size r and frequency of the transmitted sound (if the transmitter is a dipole, which is characteristic of the given situation) as:

J˜(kr)⁴=(2πr/π)⁴ (2)

Here k is the wave number of the transmitted sound. If in (1) we use the extreme situation where

Δ=c/2f, then from (2) we get: J˜(λr/Δ)⁴ (3)

It follows from (3) that at the given characteristics of the transmitter the intensity of the sound transmitted by it in the drying chamber and consequently the drying speed of the material, depend very strongly on the ratio r/Δ. For example, at a given capacity of the external energy source supplying the sound transmitter, and the fixed value of its linear size r the division of the drying chamber into 4 sections as it is shown in FIG. 1, improves the sound intensity in each section, and consequently the drying speed of the material, by 16 times.

It should be noted that the discharge of slightly heated (to 40-60°) air for heating the material to be dried consumes much less energy than needed for supplying of sound transmitters.

As a result of dividing the drying chamber into several soundproof sections its one-time loading, i.e. its productivity, increases significantly. Owing to the increase in sound intensity, the drying speed increases in each section in comparison to the usual one-section chamber with the same power supplied to the sound transmitter, and, accordingly, the drying time is reduced. As a consequence, the device allows of lower power consumption, which means improvement in technical and economic parameters of drying.

Thus the design of the device is simple and technological.

What is claimed is:

1. A device for drying capillary porous materials, comprising:
a drying chamber supplied with a source of sound, and is distinguished by the installation of soundproof partitions in the drying chamber that divide its inner volume into isolated sections, each section being supplied with a separate source of sound; and
a source of heated air, executed in such a way that heated air is supplied from said source to each section of the drying chamber.

2. The device according to claim 1, distinguished by horizontal installation of soundproof partitions in the drying chamber.

3. The device according to claim 1, distinguished by vertical installation of soundproof partitions in the drying chamber.

4. The device according to claim 1, distinguished by horizontal and vertical installation of soundproof partitions in the drying chamber.

5. The device according to claim 1, distinguished by construction of soundproof partitions made from two layers of metal between which a soundproof material is located.

6. The device according to claim 1, distinguished by the drying chamber equipped with a sound absorber.

7. The device according to claim 1, distinguished by a source of heated air comprising a means of heating air and a means of air supply to the drying chamber.
